(19) United States
(12) Patent Application Publication
(10) Pub. No.: US 2010/0142783 A1
(43) Pub. Date: Jun. 10, 2010

(54) AXIAL CENTERLINE FOLLOWING DISPLAY OF CT COLONOGRAPHY IMAGES

(75) Inventors: C. Daniel Johnson, Scottsdale, AZ (US); Michael J. Carston, Rochester, MN (US); Armando Manduca, Rochester, MN (US); Robert J. Wentz, Rochester, MN (US)

Correspondence Address: FAEGRE & BENSON LLP;PATENT DOCKETING - INTELLECTUAL PROPERTY 23/24, 2200 WELLS FARGO CENTER, 90 SOUTH SEVENTH STREET, MINNEAPOLIS, MN, 55402-3901, US

(73) Assignee: MAYO FOUNDATION FOR MEDICAL EDUCATION AND RESEARCH, Rochester, MN (US)

(21) Appl. No.: 12/523,474

(22) PCT Filed: Jan. 22, 2008
(86) PCT No.: PCT/US08/51703

§ 371 Date: Jan. 27, 2010

Related U.S. Application Data
(60) Provisional application No. 60/881,360, filed on Jan. 19, 2007.

(51) Int. Cl. G06K 9/00

(52) U.S. Cl. 382/131

(57) ABSTRACT

A method for displaying colonography images includes presenting a series of axial images of the colon at sequential locations along the colon centerline. Each image is generally centered on the centerline and presents a field of view parallel to the axial plane.

### REFERENCE TO RELATED APPLICATION

This application claims the benefit of U.S. provisional application Ser. No. 60/881,360, filed Jan. 19, 2007 and entitled Axial Centerline Following Display Of CT Colonography Images, which is incorporated herein in its entirety by reference.

### TECHNICAL FIELD

The invention is a method and system for processing colonography image data and displaying colonography images.

### BACKGROUND

Colonography, the use of electronic imaging technologies such as computed tomography (CT) to generate images of a patient's colon for purposes of colorectal cancer screening, is generally known. By way of example, these technologies are disclosed in the Johnson et al. U.S. Pat. Nos. 6,928,314 and 7,035,681, the Zalis U.S. Pat. No. 6,947,784, the Vining U.S. Pat. Nos. 6,909,913 and 7,149,564, and PCT publication no. WO 2007/030132, all of which are incorporated herein by reference. Briefly, this methodology involves obtaining a series of CT images of adjacent portions or slices of the colon. A radiologist then studies each of the images to identify any pre-cancerous polyps. Alternatively, a computer can effectively create a simulated intraluminal flight through the colon (this is also known as virtual colonoscopy). Colonography has been demonstrated to be a highly efficacious approach for detecting colorectal polyps.

Readers of CT colonography images sometimes prefer to maintain a small field of view, to maximize conspicuity of small polyps. However, this requires them to manually follow the colon throughout the abdomen and pelvis. Manually following the colon as it curves through the body can at times be difficult and may distract the reader from his or her primary task, which is to locate polyps and lesions within the colon. The reader may also sometimes recenter the segment of interest in the workstation display, further complicating the primary task. Conversely, the need for recentering may be reduced if the image is viewed at a large field of view, but then any polyps may be more difficult to identify.

### SUMMARY

The invention is an improved method and system for processing and displaying colonography image data. In one embodiment of the invention the image data is processed to identify a centerline of the colon. A series of axial image data sets representative of images of the colon at sequential locations along the centerline is generated. Each image is generally centered on the centerline and presents a field of view parallel to an axial plane.

### BRIEF DESCRIPTION OF THE DRAWINGS

FIG. 1 is an image of a colon with a centerline traversing the length of the colon.

FIGS. 2A-2C are axial centerline-following images of a colon at a series of sequential positions within the colon in accordance with one embodiment of the invention.

FIG. 3 is a schematic illustration of the imaging method of the invention.

### DESCRIPTION OF THE INVENTION

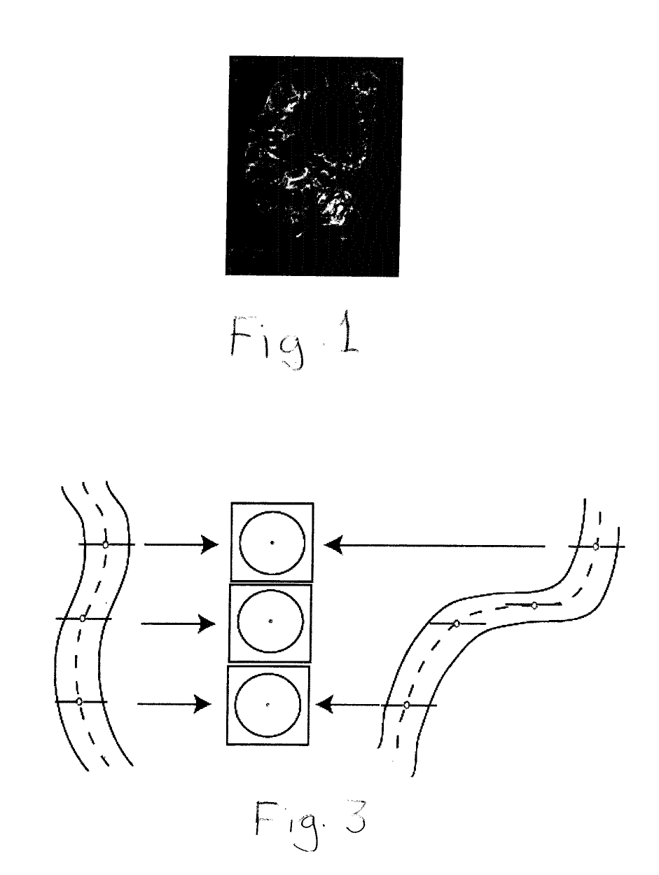

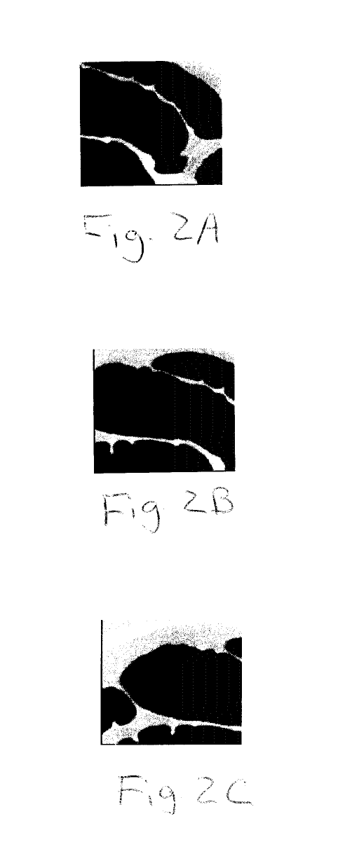

This invention is a display technique based on automatic generation of a midline trace or centerline of the colon and then display of a sequence of images that are centered on this trace and follow along it. Such a trace is shown in FIG. 1, and many techniques for generating such a trace are known and described in the literature. A relatively small (and in some embodiments adjustable) field of view of an axial or transverse slice is displayed around the current centerline position. The radiologist controls the centerline position currently being observed with a mouse, slider bar or other keyboard or GUI control. As the radiologist advances through the centerline, the image shown is constantly updated to be from the slice corresponding to the current centerline position and centered on its location. FIGS. 2A-2C illustrate axial centerline following, displaying sample views at three closely spaced points along the centerline in the transverse colon. The field of view is approximately 80 mm wide. As the radiologist scans along the centerline, the current centerline point (bright dot in the figure) remains at the center of the image, and a small field of view is displayed around it, maintaining the current segment of interest in the center of the display.

The field of view (FOV) is preferably large enough to show sufficient detail in the image, yet small enough that the reader can view the image relatively quickly. The appropriate size FOV can be determined. Alternatively, GUI or other controls can be installed to make this adjustable by the user. Axial slices centered on sections of the colon parallel to the axial plane may not allow the reader to see polyps located on the colon wall a few slices away. One approach to alleviate this issue is to automatically page back and forth several slices in the axial direction while in the transverse colon. The transverse colon can be identified automatically by measuring the angle of the centerline tangent relative to the XY plane. Another solution is for the reader to manually pause the centerline following and page back and forth manually. The use of sagittal and coronal views for the centerline following can also be implemented. Such a display system can automatically keep track of whether all necessary slices have been viewed, and alert the user when some areas of the colon have not been observed. The invention can help keep the observer's attention focused on the colon, and display the colon at an optimal size for lesion detection. This can result in faster reading times with less disruption of concentration, and may yield both time savings and improvements in accuracy.

FIG. 3 is a schematic illustration of axial colon following in accordance with the invention. Image slices are generated in the transverse orientation and are centered in the lumen.

Although the invention has been described with reference to preferred embodiments, those skilled in the art will recognize that changes can be made in form and detail without departing from the spirit and scope of the invention.

What is claimed is:

1. A method for operating a computer to process colonography image data, including:
processing the data to identify a centerline of the colon; and
generating a series of axial image data sets representative of images of the colon at sequential locations along the centerline, wherein each image is generally centered on the centerline and presents a field of view parallel to an axial plane.

2. The method of claim 1 wherein:
the method further includes receiving operator input field of view information representative of a desired field of view size; and
generating the image data sets includes generating image data sets representative of an image having the desired field of view size as a function of the field of view information.

3. The method of claim 2 wherein:
the method further includes receiving operator input centerline position information representative of a selected position on the centerline; and
generating the image data sets includes generating an image data set representative of the image at the selected centerline position.

4. The method of claim 3 and further including generating a colon image data set representative of the colon and having an indicia representative of the selected centerline position.

5. The method of claim 1 and further including generating a colon image data set representative of the colon and having an indicia representative of the image position.

6. The method of claim 1 wherein:
the method further includes receiving operator input centerline position information representative of a selected position on the centerline; and
generating the image data sets includes generating an image data set representative of the image at the selected centerline position.

7. A method for displaying colonography images, including presenting a series of axial images of the colon at sequential locations along the colon centerline, wherein each image is generally centered on the centerline and presents a field of view parallel to an axial plane.

8. The method of claim 7 wherein:
the method further includes receiving operator input field of view information representative of a desired field of view size; and
presenting the images includes presenting images having a field of view size determined as a function of the field of view information.

9. The method of claim 8 wherein:
the method further includes receiving operator input centerline position information representative of a selected position on the centerline; and
presenting the images includes presenting images at positions in the colon determined as a function of the position information.

10. The method of claim 9 and further including generating a colon image having an indicia representative of the position of the displayed axial image.

11. The method of claim 7 wherein:
the method further includes receiving operator input centerline position information representative of a selected position on the centerline; and
presenting the images includes presenting images at positions in the colon determined as a function of the position information.

12. The method of claim 6 and further including generating a colon image having an indicia representative of the position of the displayed axial image.

13. The method of claim 7 and further including presenting indicia indicating images not presented.
